(19) United States
(12) Patent Application Publication
(10) Pub. No.: US 2016/0245120 A1
(43) Pub. Date: Aug. 25, 2016

(54) METHOD FOR PRODUCING A COMPONENT, AND THE CORRESPONDING COMPONENT

(71) Applicant: MTU Aero Engines AG, Munich (DE)

(72) Inventors: Dagobert GOEPFERT, Munich (DE); Alexander GINDORF, Schwabhausen (DE); Marcus KLEMM, Gilching (DE)

(21) Appl. No.: 15/047,424

(22) Filed: Feb. 18, 2016

(30) Foreign Application Priority Data
Feb. 24, 2015 (DE) 102015203234.5

(51) Int. Cl. F01D 25/24

(52) U.S. Cl. CPC F01D 25/24; F05D 2220/321; F05D 2230/10; F05D 2230/31; F05D 2230/232; F05D 2230/25; F05D 2230/40

(57) ABSTRACT

The invention relates to a method for producing a component, in particular a housing (30) of a gas turbine. Firstly, a rotationally symmetrical forged blank (2) is provided. Then, additional material composed of at least one substance is applied to the surface of the blank (18, 20) at at least one location. Subsequently, material is removed until the final contour of the finished component (30) is attained.

### CROSS-REFERENCE TO RELATED APPLICATIONS

The present application claims priority under 35 U.S.C. §119 of German Patent Application No. 10 2015 203 234.5, filed Feb. 24, 2015, the entire disclosure of which is expressly incorporated by reference herein.

### BACKGROUND OF THE INVENTION

1. Field of the Invention

The invention relates to a method for producing a component and the corresponding component.

2. Discussion of Background Information

Certain components of gas turbines, such as housings, have radially outwardly directed flanges on their axial ends. Since the housings must exhibit a certain strength while at the same time being of the lowest possible weight, such that, for example, no rotating parts such as rotor blades can pierce through the housing wall, said components are preferably forged. The housing wall furthermore commonly has functional elements such as hooks, eyelets, reinforcement ribs and/or reinforcements for borescope and cooling air eyelets. Some such functional elements cannot be readily produced by forging. Therefore, at the locations at which the functional elements are arranged on the subsequently finished housing, sufficient material is integrally fowled during the forging process. This has the effect that the functional elements must be milled out of the forged blank. However, during the forging process, the substance oversize required for the functional element is formed over the entire circumference of the housing. However, the functional elements are arranged only at certain locations on the circumference, such that, at those locations on the circumference at which no functional elements are arranged, a large mass of substance must be milled away until the thickness of the housing wall is attained, which is cumbersome. A cheaper chip-removing process, such as turning, is not available, because the housing wall with the functional elements is generally asymmetrical in said regions.

For the production of the housing flanges, there are two approaches. In the first approach, the forged blank has the radial extent of the flange over the entire axial length. The radial extent of the finished housing at the level of the flange is for example 30 mm. The thickness of the housing wall may for example be only 4 mm. It would thus be necessary for up to 26 mm of material to be removed over approximately the entire axial length of the housing. This is long-winded, expensive and therefore not economical.

In the second approach, the flanges are likewise jointly formed during the forging process, but the oversize on the axial height of the housing wall is for example only 20 mm. The protruding 10 mm of the flanges in this case form undercuts in the forging mold or casting mold. In order that said flanges can be jointly formed during the forging process, it is necessary for more than two dies to be provided in order that the blank can be removed from the mold. This has the disadvantage that the production costs for the blank increase.

In view of the foregoing, it would be advantageous to have available a method for producing a component, which method is faster, less expensive and more precise.

### SUMMARY OF THE INVENTION

The present invention provides a method for producing a component, in particular a housing of a gas turbine. The method comprises:
a.) providing a rotationally symmetrical forged blank,
b.) applying additional material of at least one substance to a surface of the blank at at least one location,
c.) removing material until a final contour of a finished component is attained.

In one aspect of the method of the invention, the forged blank may be substantially in the shape of a frustum. Further, a flange region which lengthens the frustum parallel to its axis of symmetry may be integrally formed on at least one end of the frustum.

In another aspect of the method, in b.) the application of additional material may be performed by laser deposition welding and/or by kinetic cold gas compaction and/or the additional material may be applied with an oversize of at most 1 mm, for example at most 0.5 mm, in relation to the final contour and/or the additional material may be applied in layers and/or the material may be applied only at the at least one location which, in the final contour, protrudes out of an original surface of the forged blank and/or the material may be applied such that a functional element of the component is formed. For example, the functional element may be a flange extension which runs perpendicular to the axis of symmetry, and radially outward, on an axial end of the flange region.

In a yet another aspect of the method, in b.) the composition (substance) of the additional material may differ from the composition (substance) of the forged blank.

In a still further aspect of the method, in c.), the material may be removed only at at least one functional location and/or the removal of material may be performed mechanically and/or chemically.

In another aspect, between a.) and b.) of the present method a contact surface may be worked into the forged blank and/or between b.) and c.) of the method the forged blank may be heat-treated with additional material.

The present invention also provides a component which has been produced in accordance with the method of the instant invention as set forth above (including the various aspects thereof). For example, the component may be a turbine central housing and/or a housing for a low-pressure turbine.

As set forth above, the invention relates to a method for producing a component. Firstly, a rotationally symmetrical forged blank is provided. Next, additional material composed of at least one substance is applied to the surface of the blank at at least one location. Next, material is removed until the final contour of the finished component is attained.

This has the advantage that the weight of the component is reduced, and the production costs are reduced by up to 10%.

In a further advantageous refinement of the invention, the forged blank is substantially in the shape of a frustum. This has the advantage that the forged blank has been greatly simplified. In particular, the forged blank does not have any undercuts. Here, the costs for the dies are very greatly reduced. For such a simple blank geometry without undercuts, only two dies are required. Furthermore, the shell surface of the frustum has the strength of a forged component, such that there, the wall thicknesses can be thinner than in the case of a cast substance. This in turn has the result that the finished component is of lower weight.

In a further advantageous refinement of the invention, on at least one axial end of the frustum, there is integrally formed a flange region which lengthens the frustum parallel to its axis of symmetry. It is preferably the case that both ends of the frustum have flange regions running parallel to the axis of symmetry. This has the advantage that the blank can be forged using simple dies. In particular, the die direction can run along the axis of symmetry. Other components are preferably screwed onto said flange regions at a later point in time. It is therefore important for said flange regions to have a high strength (for example that of forged substances). Furthermore, it is thus possible for blank costs of 25% to 40% to be saved.

In a further advantageous refinement of the invention, in step b.), the application is performed by way of laser deposition welding and/or by kinetic cold gas compaction.

Laser deposition welding may be performed using wire and/or powder. In the case of kinetic cold gas compaction, a carrier gas is intensely accelerated using a de Laval nozzle. The carrier gas entrains the powder particles which then strike the surface of the forged blank. Owing to the high particle speed, the powder particles deform and adhere to the surface of the blank.

In a further advantageous refinement of the invention, in step b.), the additional material is applied with an oversize of at most 1 mm, in particular of at most 0.5 mm, in relation to the final contour of the finished component. This has the advantage that the outlay during the subsequent removal of excess material is low. Furthermore, the costs for the additional material can be saved in this way.

In a further advantageous refinement of the invention, in step b.), the additional material is applied in layered fashion. This offers the possibility of applying one layer with a particular composition and another layer with a different composition.

In a further advantageous refinement of the invention, in step b.), material is applied only at the at least one location which, in the final contour, protrudes out of the original surface of the forged blank. This offers the enormous possibility of coordinating the application process with the preceding forging process. During the forging, the blank has a simplified geometry. In this case, the outer contour of the forged blank is optimized to such an extent that, firstly, forging is performed so as to yield almost the finished contour, such that subsequently only a small amount of material has to be removed, and secondly, material has to be applied only at a small number of locations. The locations at which material is to he applied are in particular regions which cannot be produced effectively, or at all, by forging, or which project merely in punctiform fashion beyond the surface of the forged part. In particular, the method is optimized such that minimal material has to be removed from the forged blank, and minimal new material has to be applied. The production costs and material costs can be enormously reduced in this way.

In a further advantageous refinement of the invention, in step b.), the material is applied such that a functional element of the component is formed. Functional elements are for example attachment parts on the component, such as hooks, eyelets etc. Such functional elements may also be flange extensions and/or reinforcements for borescope and/or cooling air eyelets. Furthermore, said functional elements may also be reinforcements struts or reinforcement ribs, which connect for example a turbine central housing (turbine center frame) to the hub of the gas turbine.

In a further advantageous refinement of the invention, the functional element is a flange extension which runs perpendicular to the axis of symmetry, and radially outward, on an axial end of the flange region. Flanges composed of a forged flange region and of an applied flange extension offer the greatest simplification potential with this method.

In a further advantageous refinement of the invention, in step b.), the substance of the additional material differs from the substance of the forged blank. Accordingly, it is for example possible for the forged blank to be produced from Ti-64 and for the functional regions to be produced from Ti 6242. Another material pairing may be IN625 for the blank and IN718 or DA718 for the additionally applied material. In particular, each loading zone on the component is provided with a corresponding substance which ensures the required strength.

In a further advantageous refinement of the invention, in step c.), material is removed only at at least one functional location. Functional locations, in particular functional surfaces, are for example openings, eyelets, bores and/or contact surfaces of the flanges. Said functional locations must conform to a predefinable degree of dimensional accuracy such that the component, when installed, is compatible with other components. Other surfaces do not need to undergo reworking. In particular, material applied in step b.) is not removed.

In a further advantageous refinement of the invention, in step c.), the removal is performed by mechanical and/or electrochemical means. The mechanical removal is performed by turning and/or milling, wherein in particular, as small a part as possible should be milled, because milling constitutes a highly time-consuming and expensive manufacturing step. Electrochemical removal (ECM—electro chemical manufacturing) is performed in a bath of electrolyte. The blank is connected to positive polarity, as anode, and the tool is connected to negative polarity, as cathode. A current flows between the two, wherein the substance of the blank then dissolves in the electrolyte.

In a further advantageous refinement of the invention, between steps a.) and b.), a contact surface is worked into the forged blank. In particular, a contact surface is turned in the interior of the flange region of the forged blank. Said contact surface can be produced in a precise manner and serves as a reference surface for the further machining, because the forged blank can be chucked and centered by way of said contact surface.

In a further advantageous refinement of the invention, between steps b.) and c.), the forged blank is heat-treated with additional material. This serves for dissipating mechanical stress in the substance. The heat treatment may be performed globally by way of a furnace. The heat treatment may however also be performed locally by way of a laser or an induction coil.

Further advantageous refinements of the invention will emerge from the dependent claims.

### BRIEF DESCRIPTION OF THE DRAWINGS

Below, exemplary embodiments of the invention will be described in more detail on the basis of schematic drawings, in which:

FIG. 1: shows a side view of a blank for a housing,

FIG. 2: shows a front view of the blank from FIG. 1, and

FIG. 3: shows a section along the line III-III in FIG. 3.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

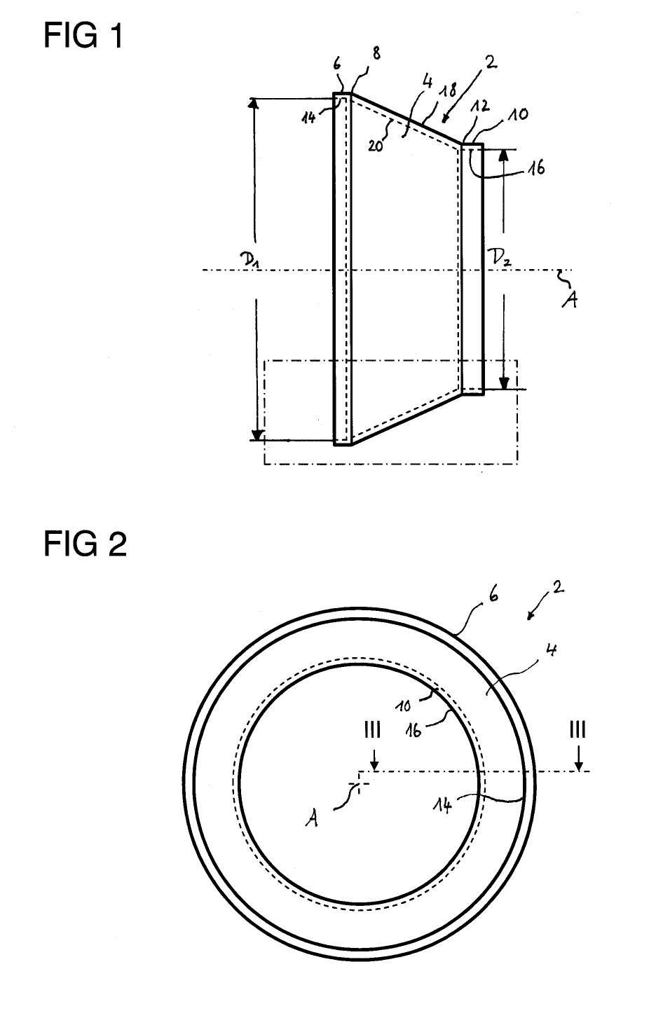

FIG. 1 and FIG. 2 show a rotationally symmetrical forged blank 2 which has a frustum 4, a first flange region 6 integrally formed on the first axial end 8 (on the left in FIG. 1) of the frustum 4, and a second flange region 10 integrally formed, in FIG. 1, on the second axial end 12 (on the right in FIG. 1) of the frustum 4. The two flange regions 6 and 10 run parallel to the axis of symmetry A, wherein the first internal diameter D₁ of the first flange region 6 is greater than the second internal diameter D₂ of the second flange region 10.

The blank 2 may for example be forged from a cylindrical tube with an internal diameter slightly smaller than the second internal diameter D₂. Here, an outer die has the external shape of the blank 2, and an inner die has the internal shape of the blank 2. The outer die could be arranged on the right-hand side in FIG. 1, and the inner die could be arranged on the left-hand side in the figure. The inner die is displaced with increasing pressure along the axis of symmetry A and forces the glowing mass of the tube into the outer die, giving rise to the shape of the forged blank 2. After cooling to room temperature, the internal surfaces of the flange regions 6 and 10 can be turned to size in chip-removing fashion, such that the dedicated contact surfaces 14 and 16 are formed. During the further machining, the blank 2 is chucked and centered by way of at least one of said contact surfaces 14 and 16.

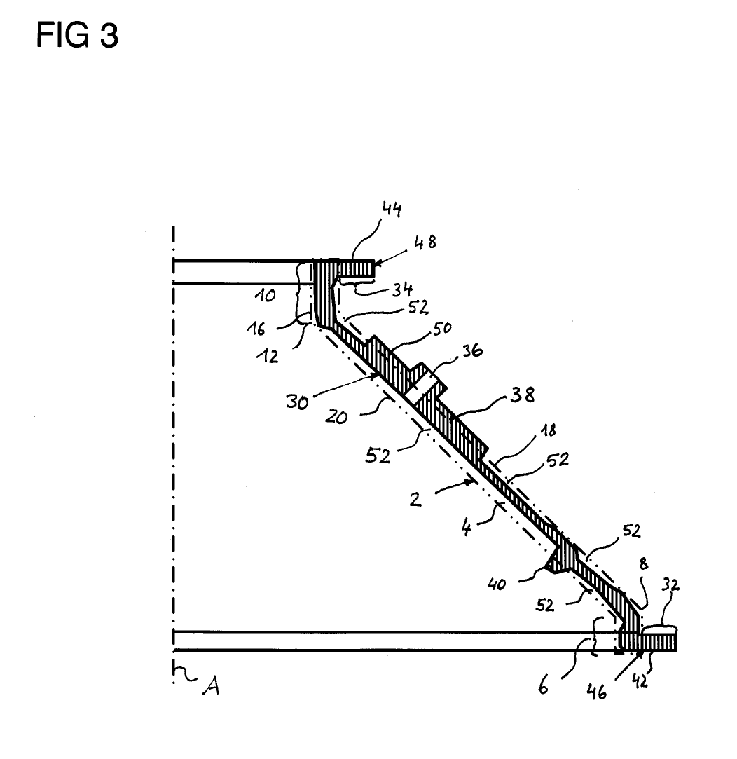

FIG. 3 shows a section along the line in FIG. 2. The section of the blank 2 is illustrated merely as a dash-double dotted line. Furthermore, the illustration in FIG. 3 substantially corresponds to an enlargement of the dash-dotted detail in FIG. 1, wherein the enlargement has been rotated 90° counterclockwise in relation to the detail. A section through a finished housing 30 is also shown by way of solid lines. This illustration shows the locations at which new material must be deposited on the forged blank 2 or material of the forged blank 2 can be removed. Accordingly, a radially outwardly running first flange extension 32 is integrally formed on the axial end of the first flange region 6 (shown here at the bottom) Analogously, a radially outwardly running second flange extension 34 is integrally formed on the axial end of the second flange region 10 (shown here at the top). Said two flange extensions 32 and 34 project beyond the original external surface 18 of the forged blank 2. Said flange extensions 32 and 34 run rotationally symmetrically over the entire circumference of the housing 30.

In the upper third, the housing 30 may have a borescope eyelet 36 or the like, around which there may be arranged a borescope reinforcement 38. A part of said borescope reinforcement 38 projects beyond the original outer surface 18 of the forged blank 2.

Such borescope eyelets 36 with reinforcements 38 are arranged for example only at 60° intervals over the circumference, such that altogether, six borescope eyelets are provided so as to be distributed uniformly over the circumference. An irregular distribution over the circumference is also conceivable.

In the lower third, the housing 30 has, on the internal side, a rotationally symmetrical reinforcement stmt 40 which projects beyond the original inner surface 20 of the forged blank 2. The flange extensions 32 and 34, the borescope reinforcement 38 and the reinforcement strut 40 may generally he referred to as functional elements of the housing 30. Here, a first flange 46 is formed from the first flange region 6 and the first flange extension 32. A second flange 48 is formed from the second flange region 10 and the second flange extension 34.

After the forging of the blank 2, said functional elements may be applied in generative fashion by way of laser deposition welding and/or by way of kinematic cold gas compaction onto the surface 18 or 20 of the forged blank 2. The functional elements may be applied in layered fashion. This offers the possibility of one layer having one alloy composition and another layer having a different alloy composition. It is preferable for the blank to have a first alloy composition, such as for example Ti-64 or IN625, and for at least one functional element to have a second alloy composition, such as for example Ti-6242, IN718 and/or DA718. It is thus conceivable for a first functional element to have a second alloy composition and for another functional element to have a third alloy composition. It is also possible for the individual functional element to have the alloy composition of the blank 2.

Aside from said abovementioned functional elements, it is possible for yet further functional elements to be integrally formed on the internal surface 20 and/or external surface 18, such as for example hooks, eyelets and/or reference elevations. “Reference elevations” refers to any elevations which are integrally formed on the external surface 18 and/or on the internal surface 20 of the blank 2 and which have a particular attitude, particular dimensions and a particular position relative to another component. The reference elevations may be of bone-shaped form. Depending on the method, pre-treatment of the surface 18 or 20 may be necessary. It is preferable for a material oversize of only at most 1 mm to be applied. The oversize may also amount to only 0.5 mm.

Thus, in step b.), material needs to be applied only at those locations at which the functional elements will later be arranged, because in this exemplary embodiment, all of the functional elements project beyond the original surfaces 18 and 20 of the blank 2.

After the application of all functional elements, the housing 30 may be heat-treated locally (for example inductively and/or with the aid of a laser) or globally (by way of a furnace) in order to reduce the internal stress in the material. Here, temperatures of 500°to 650° C. are suitable. This heat treatment is also referred to as stress relief annealing.

In a subsequent step c.), the forged blank is subjected to chip-removing or electrochemical reworking, such that material is removed. In particular, only the functional locations or functional surfaces are reworked, such that these have the final contour of the finished component. The functional surface includes the first surface 42 of the first flange 46, which first surface runs perpendicular to the axis of symmetry A and is arranged at the very bottom in FIG. 3 and runs horizontally therein, and the second surface 44 of the second flange 48, which second surface runs perpendicular to the axis of symmetry A and is arranged at the very top in FIG. 3 and runs horizontally therein. Thus, the two flange surfaces 42 and 44 are parallel to one another. It is thus ensured that the components to be fastened to the flanges 46 and 48 are correctly oriented. Further functional surfaces on the external surface of the housing 30 are conceivable. It is accordingly possible for the upper region of the borescope reinforcement 38 in FIG. 3 to have a further functional surface 50.

The regions denoted by the reference designation 52 in FIG. 3 are referred to as regions for removal. This means that the corresponding surface of the housing 30 is situated within the forged blank 2. For example, with regard to costs, it would not be necessary in the case of static gas turbines for said regions 52 of the housing 30 to be removed. In particular, weight plays a secondary role in the case of static gas turbines. The removal of said regions 52 serves in particular for reducing the weight of the housing 30. By contrast, in the case of non-static gas turbines, weight contributes to efficiency, such that the effort is made to correspondingly remove the material.

The housing 30 may be a turbine central housing (turbine center frame) or a housing for a low-pressure turbine.

While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMERALS

2 Forged blank
4 Frustum
6 First flange region
8 First axial end of 4
10 Second flange region
12 Second axial end of 4
14 First contact surface of 6
16 Second contact surface of 10
18 Original external surface of 2
20 Original internal surface of 2
30 Housing
32 First flange extension
34 Second flange extension
36 Borescope eyelet
38 Borescope reinforcement
40 Reinforcement strut
42 First flange surface
44 Second flange surface
46 First flange
48 Second flange
50 Further functional surface
52 Region for removal
A Axis of symmetry
D₁ First internal diameter of 6
D₂ Second internal diameter of 10

What is claimed is:

1. A method for producing a component, wherein the method comprises:
a.) providing a rotationally symmetrical forged blank,
b.) applying additional material of at least one substance to a surface of the blank at at least one location,
c.) removing material until a final contour of a finished component is attained.

2. The method of claim 1, wherein the component is a housing of a gas turbine.

3. The method of claim 1, wherein the forged blank is substantially in the shape of a frustum.

4. The method of claim 3, wherein a flange region which lengthens the frustum parallel to its axis of symmetry is integrally formed on at least one end of the frustum.

5. The method of claim 1, wherein in b.), application of additional material is performed by laser deposition welding and/or by kinetic cold gas compaction.

6. The method of claim 1, wherein in b.), the additional material is applied with an oversize of at most 1 mm in relation to the final contour.

7. The method of claim 6, wherein in b.), the additional material is applied with an oversize of at most 0.5 mm in relation to the final contour.

8. The method of claim 1, wherein in b,), the additional material is applied in layers.

9. The method of claim 1, wherein in b.), material is applied only at the at least one location which, in the final contour, protrudes out of an original surface of the forged blank.

10. The method of claim 1, wherein in b.), the material is applied such that a functional element of the component is formed.

11. The method of claim 10, wherein the functional element is a flange extension which runs perpendicular to an axis of symmetry, and radially outward, on an axial end of a flange region.

12. The method of claim 1, wherein in b.), a composition of the additional material differs from a composition of the forged blank.

13. The method of claim 1, wherein in c.), material is removed only at at least one functional location.

14. The method of claim 1, wherein in c.), the removal of material is performed mechanically and/or chemically.

15. The method of claim 1, wherein between a.) and b.), a contact surface is worked into the forged blank.

16. The method of claim 1, wherein between b.) and c.), the forged blank is heat-treated with additional material.

17. A component produced in accordance with the method of claim 1.

18. The component of claim 17, wherein the component is a turbine central housing.

19. The component of claim 17, wherein the component is a housing for a low-pressure turbine.
